(19) United States
(12) Patent Application Publication
(10) Pub. No.: US 2023/0139540 A1
(43) Pub. Date: May 4, 2023

(54) LIGHT SOURCE DEVICE AND PROJECTOR

(71) Applicant: Sharp NEC Display Solutions, Ltd., Tokyo (JP)

(72) Inventor: Sota HIRAHARA, Tokyo (JP)

(21) Appl. No.: 17/911,908

(22) PCT Filed: Mar. 16, 2020
(86) PCT No.: PCT/JP2020/011411

§ 371 Date: Sep. 15, 2022

(51) Int. Cl. G03B 21/20; G02B 26/00; H04N 9/31; G02B 27/28; G03B 33/12

(52) U.S. Cl. CPC G03B 21/204; G02B 26/008; G03B 21/2013; G03B 21/2066; H04N 9/3161; H04N 9/3164; G02B 27/283; G03B 33/12

(57) ABSTRACT

A light source device is provided in which the number of LD chips can be easily optimized and that has a high light utilization efficiency. The light source device includes a first light source unit that emits a first monochromatic light, a second light source unit that emits a second monochromatic light of the same color as the first monochromatic light, an optical member that splits the first monochromatic light emitted by the first light source unit into a first split light and a second split light and that integrates the first split light and the second monochromatic light emitted by the second light source unit into one optical path, and a phosphor unit that receives the second split light or the integrated light to emit fluorescent light.

### TECHNICAL FIELD

The present invention relates to a light source device including a phosphor and a projector.

### BACKGROUND ART

Patent Document 1 discloses a light source device that emits white light in which yellow fluorescent light and blue light are mixed. In this light source device, an excitation light source having a plurality of blue LDs (Laser Diodes) emits excitation light (blue LD light). The excitation light is incident on one surface of a dichroic mirror. The dichroic mirror reflects the excitation light toward a phosphor wheel. The phosphor wheel receives the excitation light to emit yellow fluorescent light in the direction of the dichroic mirror. The yellow fluorescent light is transmitted through the dichroic mirror.

A blue light source comprising a plurality of blue LDs emits blue LD light. The blue LD light is incident on the other surface of the dichroic mirror. In the dichroic mirror, the blue LD light is reflected and combined with the yellow fluorescent light that is transmitted through the dichroic mirror.

Incidentally, for the purpose of reducing the device cost, a laser module in which a plurality of LD chips is contained in one package may be applied to the excitation light source and the blue light source. There are several types of laser modules depending on the number of LD chips.

### PRIOR ART DOCUMENT

### Patent Document

Patent Document 1: JP-A-2019-158914

### DISCLOSURE OF THE INVENTION

### Problems to be Solved by the Invention

However, in the light source device described in Patent Document 1, the following problems occur when a laser module is used.

In order to obtain white light having a desired color tone, it is necessary to design so that the ratio of the number of LD chips between the blue light source and the excitation light source is set to the value of a predetermined ratio. However, when using laser modules, the number of LD chips can be set only in module units. Therefore, the degree of freedom of the design was low, and the optimization of the number of LD chips was difficult.

Further, when the number of LD chips required for the light source is different from the accommodation number of LD chips of the laser module, a laser module is used whose accommodation number of LD chips is larger than the number of LD chips required. In this case, since it is necessary to reduce the amount of light of the laser module so that a predetermined amount of light is obtained, the light utilization efficiency is reduced. In addition, the power consumption increases because LD chips are driven that were not originally required.

An object of the present invention is to solve the above problems and to provide both a light source device in which the number of LD chips can be easily optimized and that has a high light utilization efficiency, and a projector.

### Means for Solving the Problems

To achieve the above object, the light source device of the present invention includes a first light source unit that emits a first monochromatic light, a second light source unit that emits a second monochromatic light of the same color as the first monochromatic light, an optical member that splits the first monochromatic light emitted by the first light source unit into a first split light and a second split light and that integrates the first split light and the second monochromatic light emitted by the second light source unit into one optical path, and a phosphor unit that receives the second split light or the light that has been integrated into the one optical path to emit fluorescent light.

The projector of the present invention includes the light source device, a light modulation unit that modulates light emitted by the light source device to form an image, and a projection lens that projects the image formed by the light modulation unit.

### Effect of the Invention

According to the present invention, the number of LD chips can be easily optimized and the light utilization efficiency can be improved.

### BRIEF DESCRIPTION OF THE DRAWINGS

FIG. 1 is a block diagram showing a configuration of a light source device according to a first embodiment of the present invention.

FIG. 2 is a schematic diagram showing a configuration of a light source device according to a second embodiment of the present invention.

FIG. 3A is a side view schematically showing a configuration of a light source device according to a third embodiment of the present invention.

FIG. 3B is a top view schematically showing the configuration of the light source device according to the third embodiment of the present invention.

FIG. 4A is a side view schematically showing a configuration of a light source device according to a fourth embodiment of the present invention.

FIG. 4B is a top view schematically showing the configuration of the light source device according to the fourth embodiment of the present invention.

FIG. 5 is a top view schematically showing a configuration of a light source device according to a fifth embodiment of the present invention.

FIG. 6 is a schematic diagram showing a configuration of a light source device according to a sixth embodiment of the present invention.

FIG. 7 is a schematic diagram showing a configuration of a light source device according to a seventh embodiment of the present invention.

FIG. 8 is a schematic diagram showing a configuration of a projector according to an embodiment of the present invention.

### BEST MODE FOR CARRYING OUT THE INVENTION

Next, embodiments of the present invention will be described with reference to the drawings.

### First Embodiment

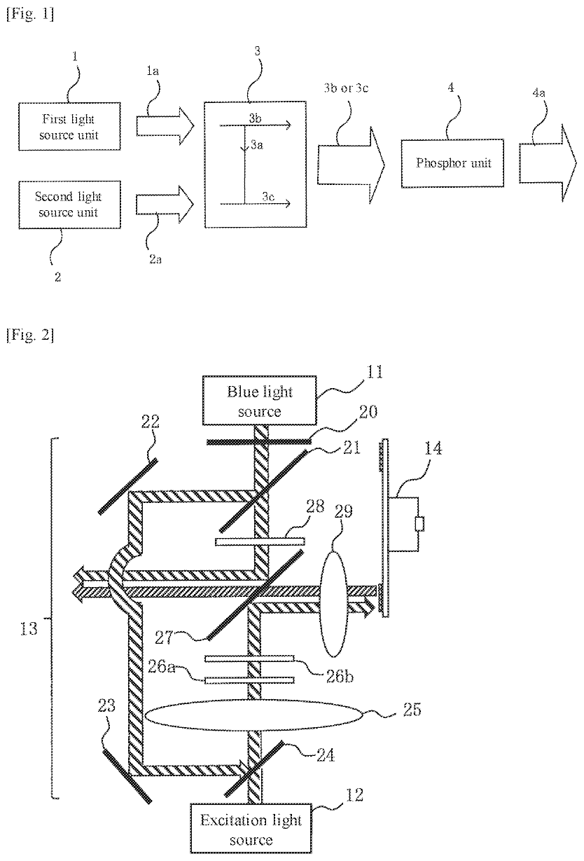

FIG. 1 is a block diagram showing the configuration of a light source device according to a first embodiment of the present invention.

Referring to FIG. 1, the light source device includes first light source unit 1, second light source unit 2, optical member 3, and phosphor unit 4. First light source unit 1 emits first monochromatic light 1a. Second light source unit 2 emits second monochromatic light 2a of the same color as first monochromatic light 1a. Optical member 3 splits first monochromatic light 1a emitted by first light source unit 1 into first split light 3a and second split light 3b and integrates first split light 3a and second monochromatic light 2a emitted by second light source unit 2 into one optical path. Phosphor unit 4 receives second split light 3b or integrated light 3c integrated into the one optical path (first split light 3a+second monochromatic light 2a) to emit fluorescent light 4a.

In the light source device of the present embodiment, for example, when integrated light 3c is used as excitation light, second split light 3b is blue light, and conversely, when second split light 3b is used as excitation light, integrated light 3c is blue light. In the light source device of the present embodiment, first split light 3a, which is a part of first monochromatic light 1a emitted by first light source unit 1, can be turned to the side of second light source unit 2. According to this configuration, even when a laser module is used to constitute first light source unit 1 and second light source unit 2, by adjusting the division ratio between first split light 3a and second split light 3b, the light quantity ratio between excitation light and blue light can be set to the value of a desired ratio. Thus, by enabling the adjustment of the division ratio, it is possible to easily perform the optimization of the number of LD chips which was difficult to achieve only by adjustment in module units, and it is possible to improve the light utilization efficiency. Further, since it is not necessary to drive LD chips wastefully such as in a configuration in which LD chips which are not originally required are driven, it is possible to reduce the consumption of power.

Hereinafter, the operation and effect will be described in detail.

One of first light source unit 1 and second light source unit 2 is used as an excitation light source, and the other is used as a blue light source. For example, in the case of exciting phosphor unit 4 with integrated light 3c, light obtained by color-synthesizing second split light 3b and fluorescent light 4a into one optical path is the light output from the light source device. On the other hand, when the phosphor unit is excited with second split light 3b, light obtained by color-synthesizing integrated light 3c and fluorescent light 4a into one optical path is the light output from the light source device.

For example, in order to obtain output light of a desired color tone, the ratio of the numbers of LD chips between the excitation light source and the blue light source is set to 45:15. In this case, the number of LD chips required for the blue light source is 15, and the number of LD chips required for the excitation light source is 45. Under this condition, we will consider a case in which a laser module with 20 LD chips is used to construct the excitation light source and the blue light source, and in which a part of the light emitted by the blue light source is turned to the side of the excitation light source. The number of modules of the excitation light source is 2 and the number of modules of the blue light source is 1. In this case, the number of LD chips of the excitation light source is 40, which is five less than 45 that is the number of chips required to obtain the desired color tone. On the other hand, the number of LD chips of the blue light source is 20, which is five more than 15 that is the number of chips required to obtain the desired color tone. Therefore, by turning the amount of light corresponding to the five LD chips from the blue light source to the side of the excitation light source, it is possible to obtain an output light of the desired color tone.

In the configuration shown in FIG. 1, first light source unit 1 is used as the blue light source, second light source unit 2 is used as the excitation light source, and the amount of light corresponding to the five LD chips from first light source unit 1 is diverted to the side of second light source unit 2. Specifically, the division ratio between first split light 3a and second split light 3b is adjusted so that the ratio between the amount of second split light 3b and the amount of integrated light 3c (first split light 3a+second monochromatic light 2a) becomes 3:1 (=45:15). This makes it possible to obtain the output light of the desired color tone. Thus, according to the light source device of the present embodiment, since the output light of the desired color tone can be obtained by adjusting the division ratio between first split light 3a and second split light 3b, the degree of freedom in design can be improved, and the optimization of the number of LD chips can be easily performed.

Further, according to the light source device of the present embodiment, rather than reducing the amount of light of first light source unit 1, since first split light 3a which is a part of first monochromatic light 1a emitted by first light source unit 1 is turned to the side of second light source unit 2, the light utilization efficiency is improved. In addition, since it is not necessary to drive LD chips wastefully, it is possible to reduce the consumption of power.

In the light source device of the present embodiment, the configuration shown in FIG. 1 is an example and can be changed as appropriate.

For example, in a case where phosphor unit 4 is excited by integrated light 3c to emit fluorescent light 4a, a color synthesizing unit may be provided for color-synthesizing second split light 3b and fluorescent light 4a emitted by phosphor unit 4 into one optical path. In this case, a part of the light emitted by the blue light source is turned to the excitation light source.

When phosphor unit 4 is excited by second split light 3b to emit fluorescent light 4a, a color light synthesizing unit may be provided for color-synthesizing integrated light 3c and fluorescent light 4a emitted by phosphor unit 4 into one optical path. In this case, a part of the light emitted by the excitation light source is turned to the blue light source.

Further, optical member 3 may include a retardation plate and a first polarization beam splitter by which first polarized light is reflected and through which second polarized light that is different from the first polarized light is transmitted. In this case, first monochromatic light 1a emitted by first light source unit 1 is incident to one surface of the first polarization beam splitter via the retardation plate. The first polarization beam splitter splits first monochromatic light 1a into first split light 3a made of the first polarized light and second split light 3b made of the second polarized light.

In the above case, second light source unit 2 emits second monochromatic light 2a made of the second polarized light, and second monochromatic light 2a may be incident to the other surface of the first polarization beam splitter. In this case, second monochromatic light 2a exits from one surface of the first polarization beam splitter on the same optical path as first split light 3a made of the first polarized light.

Optical member 3 may further include a second polarization beam splitter by which first polarized light is reflected and through which second polarized light is transmitted. In this case, second light source unit 2 emits second monochromatic light 2a made of the second polarized light, and second monochromatic light 2a enters one surface of the second polarization beam splitter. Furthermore, first split light 3a made of the first polarized light enters the other surface of the second polarization beam splitter. In the second polarization beam splitter, the second monochromatic light 2a exits from the other surface on the same optical path as first split light 3a made of the first polarized light reflected by the other surface.

Second light source unit 2 may emit a plurality of light beams, which are second monochromatic light 2a, in the same direction and in a state in which each light beam is spatially separated from the others. In this case, optical member 3 includes a reflecting member that is provided in a space that does not block each beam in the optical path that includes the plurality of light beams and in which first split light 3a made of the first polarized light is reflected in the same direction as the exit direction of the plurality of light beams.

First light source unit 1 may include at least one first laser module comprising a plurality of LD chips, and second light source unit 2 may include a plurality of second laser modules, each module comprising a plurality of LD chips.

### Second Embodiment

FIG. 2 is a schematic diagram showing the configuration of a light source device according to the second embodiment of the present invention. Incidentally, in FIG. 2, the optical paths and the optical elements are shown schematically, and their sizes and shapes may be different from an actual example. For example, for convenience, the figure shows a state in which one optical path jumps over another optical path, but in practice, each optical path is straight and is arranged to intersect with each other in a spatially separated state.

Referring to FIG. 2, the light source device includes blue light source 11, excitation light source 12, optical member 13, and phosphor unit 14. Both blue light source 11 and excitation light source 12 are composed of laser modules each comprising a plurality of LD chips, each LD chip emitting blue LD light (linearly polarized light) that is monochromatic light. Each LD chip is provided with a collimator lens that converts the emitted light into a parallel light beam.

Phosphor unit 14 is excited by blue LD light and emits yellow fluorescent light. As phosphor unit 14, for example, a phosphor wheel can be used. The phosphor wheel comprises a rotation substrate. On one surface of the rotation substrate, a phosphor layer including a phosphor that emits yellow fluorescent light is formed along the circumferential direction. Between the phosphor layer and the rotation substrate, a reflection member is provided that reflects the fluorescent light incident from the phosphor layer to the phosphor layer side. Incidentally, by constituting the rotation substrate by a metal material, it is possible to omit the reflection member.

Optical member 13 includes retardation plate 20, polarization beam splitter 21, mirrors 22 and 23, light integrating unit 24, reduction optical system 25, fly-eye lenses 26a and 26b, dichroic mirror 27, diffusion plate 28, and condenser lens 29.

Blue LD light (linearly polarized light) emitted by blue light source 11 is incident on one surface of polarization beam splitter 21 via retardation plate 20. Retardation plate 20 is an element that gives a phase difference between the two orthogonal polarization components to change the state of the incident polarization. As retardation plate 20, for example, a crystal plate such as quartz, a half-wave plate, a quarter-wave plate, or the like can be used. Blue LD light that has passed through retardation plate 20 includes P-polarized light and S-polarized light. Polarization beam splitter 21 is disposed at an inclination of 45 degrees with respect to the optical axis of blue light source 11. Polarization beam splitter 21 is configured to reflect the S-polarized light and transmit the P-polarized light. The reflection angle of the S-polarized light is 45 degrees. Here, the reflection angle is the angle formed between a normal line perpendicular to the incident surface and the traveling direction of the reflected light. Retardation plate 20 and polarization beam splitter 21 are formed so that the division ratio between the S-polarized light and the P-polarized light becomes the value of a desired division ratio.

S-polarized blue LD light reflected by polarization beam splitter 21 is incident to light integrating unit 24 via mirror 22 and mirror 23. Light integrating unit 24 integrates S-polarized blue LD light and blue LD light emitted by excitation light source 12 into one optical path.

For example, excitation light source 12 may emit a plurality of light beams in the same direction in a state in which each beam is spatially separated from the other light beams, and the mirrors that constitute light integrating unit 24 may be provided in the optical path that includes the light beams in a space that does not block each light beam. In this case, the mirrors reflect the S-polarized blue LD light in the same direction as the exit direction of excitation light source 12.

As another example, light integrating unit 24 may be constituted by a polarization beam splitter disposed at an inclination of 45 degrees with respect to the optical axis of excitation light source 12. In this case, excitation light source 12 emits P-polarized blue LD light. The polarization beam splitter transmits the P-polarized blue LD light emitted by excitation light source 12 and reflects S-polarized blue LD light from mirror 23 in the same direction as the exit direction of the P-polarized blue LD light.

Integrated light integrated by light integrating unit 24 is used as excitation light for exciting phosphor unit 14. The integrated light from light integrating unit 24 enters the first surface of dichroic mirror 27 through reduction optical system 25 and fly-eye lenses 26a and 26b. Reduction optical system 25 reduces the light beam diameter of the integrated light from light integrating unit 24. By reducing the light beam diameter, it is possible to reduce the size of the optical system that follows reduction optical system 25. Fly-eye lenses 26a and 26b constitute a light equalizing element that realizes uniform illuminance distribution on the irradiation surface of phosphor unit 14.

Dichroic mirror 27 has the characteristic of reflecting light in the blue wavelength range and transmitting light in other wavelength ranges within the visible wavelength range. Dichroic mirror 27 reflects integrated light at a reflection angle of 45 degrees. Integrated light reflected by the first surface of dichroic mirror 27 is irradiated to phosphor unit 14 via condenser lens 29. Phosphor unit 14 receives the integrated light, which is excitation light, and emits yellow fluorescent light toward the condenser lens 29 side. The yellow fluorescent light emitted from phosphor unit 14 is incident on the first surface of dichroic mirror 27 via condenser lens 29. Condenser lens 29 has a function of condensing integrated light, which is excitation light, on the irradiation surface of phosphor unit 14, and a function of converting yellow fluorescent light from phosphor unit 14 into pseudo-parallel light.

P-polarized blue LD light transmitted through polarization beam splitter 21 is incident on the second surface (the surface opposite to the first surface) of dichroic mirror 27 through diffusion plate 28. Dichroic mirror 27 transmits yellow fluorescent light incident on the first surface and reflects blue LD light incident on the second surface in the transmission direction of the yellow fluorescent light. That is, dichroic mirror 27 color-synthesizes the blue LD light and the yellow fluorescent light into one optical path. Light color-synthesized by dichroic mirror 27 is the output light (white) of the light source device of the present embodiment.

Incidentally, diffusion plate 28 is used to reduce speckle noise. Here, speckle noise is a speckle-like noise generated when forming a projected image using a laser beam.

In the light source device of the present embodiment as well, a portion of the emitted light of blue light source 11 can be turned to the side of excitation light source 12, whereby the same effect can be obtained as in the first embodiment.

Further, by configuring retardation plate 20 and polarization beam splitter 21 so that the division ratio between S-polarized light and P-polarized light becomes the value of a desired division ratio, it is possible to obtain output light of a desired color tone. For example, by rotating retardation plate 20 with the optical axis of blue light source 11 as the rotation axis, it is possible to adjust the division ratio of the S-polarized light and P-polarized light.

### Third Embodiment

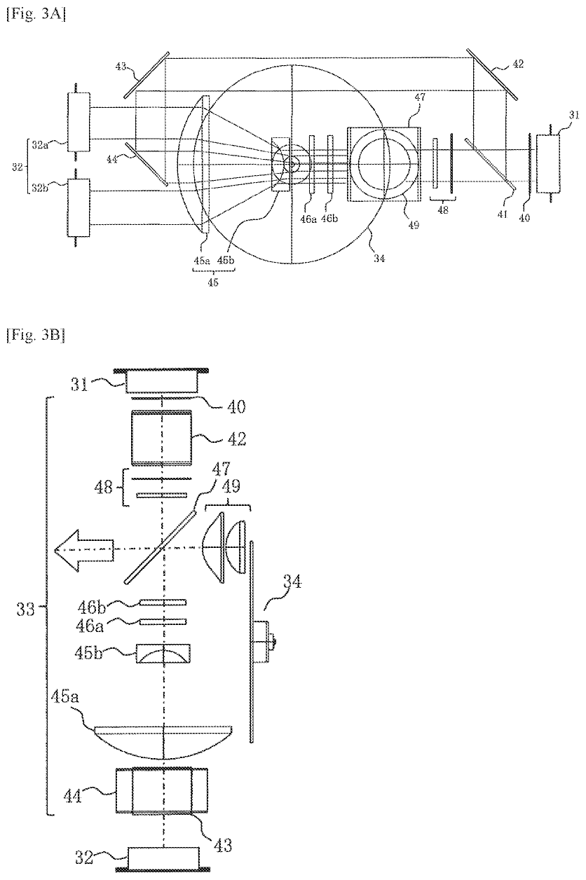

FIG. 3 is a schematic diagram showing the configuration of a light source device according to a third embodiment of the present invention disclosure. FIG. 3A is a side view and FIG. 3B is a top view.

Referring to FIG. 3A and FIG. 3B, the light source device includes laser module 31 that is a blue light source, excitation light source 32, optical member 33, and phosphor unit 34. Excitation light source 32 includes two laser modules 32a and 32b. Each of laser modules 31, 32a, and 32b has the same configuration, and here, each module is one in which 24 blue LD chips are accommodated in one package. Incidentally, the number of blue LD chips of the laser modules can be changed as appropriate.

Phosphor unit 34 has a structure similar to that of phosphor unit 14 described in the second embodiment. Optical member 33 includes retardation plate 40, polarization beam splitter 41, mirrors 42-44, reduction optical system 45, fly-eye lenses 46a and 46b, dichroic mirror 47, diffusion member 48, and condenser lens 49. Optical member 33 also has basically the same configuration as optical member 13 described in the second embodiment but is different in that light integrating unit 24 is constituted by mirror 44.

In the present embodiment, mirror 44 is provided in a space that does not block the respective light beams in the optical path that includes the parallel light beams emitted by each of laser modules 32a and 32b. Specifically, as shown in FIG. 3A, laser modules 32a and 32b are arranged one over the other. Laser modules 32a and 32b include a light emitting portion that is made of a plurality of LD chips arranged in a matrix and a support portion for supporting the light emitting portion. Since the support portion is larger than the light emitting portion, when laser modules 32a and 32b are arranged on the same plane, a certain amount of space is provided between laser modules 32a and 32b. Mirror 44 can be disposed in the space between laser modules 32a and 32b and is formed in a size capable of reflecting parallel light beams from laser module 31.

Mirror 44 integrates S-polarized blue LD light from polarization beam splitter 41 and blue LD light emitted by laser modules 32a and 32b into one optical path. Integrated light integrated by mirror 44 enters the first surface of dichroic mirror 47 through reduction optical system 45 and fly-eye lenses 46a and 46b. Reduction optical system 45 includes multiple lenses 45a and 45b for reducing the light beam diameter of the integrated light. Fly eye lenses 46a and 46b constitute a light equalizing element. Dichroic mirror 47 reflects the integrated light toward phosphor unit 34. Integrated light reflected by dichroic mirror 47 is incident to phosphor unit 34 via condenser lens 49.

Yellow fluorescent light emitted from phosphor unit 34 enters the first surface of dichroic mirror 47 via condenser lens 49. On the other hand, P-polarized blue LD light transmitted through polarization beam splitter 41 is incident on the second surface of dichroic mirror 47 through diffusion member 48. Dichroic mirror 47 transmits the yellow fluorescent light incident on the first surface and reflects the blue LD light incident on the second surface in the transmission direction of the yellow fluorescent light. That is, dichroic mirror 47 color-synthesizes the blue LD light and the yellow fluorescent light into one optical path.

In the light source device of the present embodiment as well, a portion of the emitted light of laser module 31 that is a blue light source can be turned to the side of excitation light source 32, whereby the same effect can be obtained as in the first embodiment.

Further, by forming retardation plate 40 and polarization beam splitter 41 so that the division ratio between S-polarized light and P-polarized light becomes the value of a desired division ratio, output light of a desired color tone can be obtained.

### Fourth Embodiment

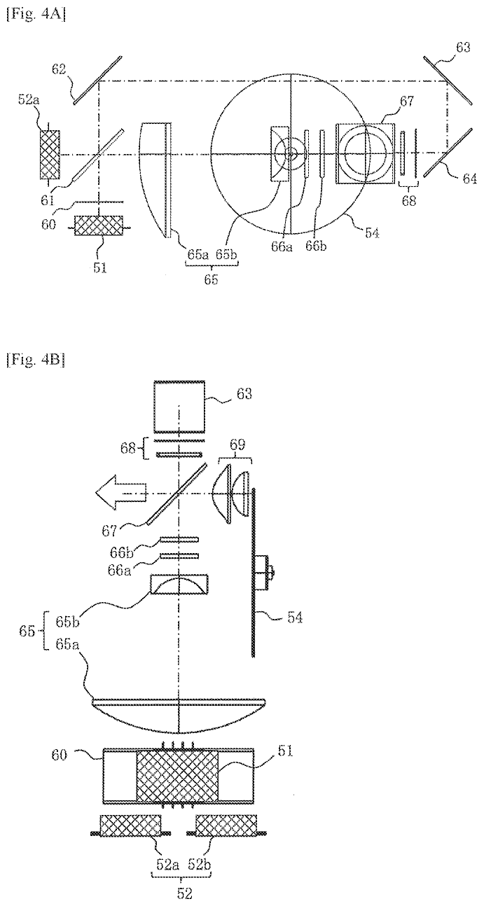

FIG. 4 is a schematic diagram showing the configuration of a light source device according to a fourth embodiment of the present invention. FIG. 4A is a side view and FIG. 4B is a top view.

Referring to FIG. 4A and FIG. 4B, the light source device includes laser module 51 that is a blue light source, excitation light source 52, optical member 53, and phosphor unit 54. Excitation light source 52 includes two laser modules 52a and 52b. Laser modules 51, 52a, and 52b are the same as laser modules 31, 32a, and 32b described in the third embodiment. However, laser module 52a and 52b are arranged side by side in the lateral direction rather than one over the other in a vertical direction.

Phosphor unit 54 has the same structure as that of phosphor unit 14 described in the second embodiment. Optical member 53 includes retardation plate 60, polarization beam splitter 61, mirrors 62-64, reduction optical system 65, fly-eye lenses 66a and 66b, dichroic mirror 67, diffusion member 68, and condenser lens 69.

The optical axis of laser module 51 is perpendicular to the optical axis of excitation light source 52, and polarization beam splitter 61 is provided at the position at which the optical axes intersect. Blue LD light (linearly polarized light) emitted by laser module 51 is incident on the first surface of polarization beam splitter 61 via retardation plate 60. Retardation plate 60 is the same as retardation plate 20 described in the second embodiment. Blue LD light (P-polarized light) emitted by laser modules 52a and 52b is incident on the second surface (the surface opposite to the first surface) of polarization beam splitter 61.

Polarization beam splitter 61 transmits P-polarized light and reflects S-polarized light. Of blue LD light that has passed through retardation plate 60, P-polarized light is transmitted through polarization beam splitter 61, whereas S-polarized light is reflected by the first surface of polarization beam splitter 61. Blue LD light (P-polarized light) emitted by laser modules 52a and 52b is transmitted through polarization beam splitter 61. That is, polarization beam splitter 61 integrates S-polarized blue LD light from retardation plate 60 and P-polarized blue LD light from laser modules 52a and 52b into one optical path.

Integrated light integrated by polarization beam splitter 61 is incident on the first surface of dichroic mirror 67 through reduction optical system 65, which is made up of multiple lenses 65a and 65, and fly-eye lenses 66a and 66b. Reduction optical system 65 and fly-eye lenses 66a and 66b have the same structure as reduction optical system 45 and fly-eye lenses 46a and 46b described in the third embodiment. Dichroic mirror 67 reflects integrated light toward phosphor unit 54. Integrated light reflected by dichroic mirror 67 is incident to phosphor unit 54 via condenser lens 69. Yellow fluorescent light emitted from phosphor unit 54 enters the first surface of dichroic mirror 67 through condenser lens 69.

On the other hand, P-polarized blue LD light that has passed through retardation plate 60 and transmitted through polarization beam splitter 61 enters the second surface (the surface opposite to the first surface) of dichroic mirror 67 through mirrors 63 to 64 and diffusion member 68. Dichroic mirror 67 has the same structure as dichroic mirror 47 described in the third embodiment. Dichroic mirror 67 transmits the yellow fluorescent light incident on the first surface and reflects the blue LD light incident on the second surface in the transmission direction of the yellow fluorescent light. That is, dichroic mirror 67 color-synthesizes the blue LD light and the yellow fluorescent light into one optical path.

In the light source device of the present embodiment as well, a portion of the emitted light of laser module 51, which is a blue light source, can be turned to the side of excitation light source 52, whereby the same effect can be obtained as in the first embodiment.

Further, by forming retardation plate 60 and polarization beam splitter 61 so that the division ratio between S-polarized light and P-polarized light becomes the value of a desired division ratio, it is possible to obtain output light of a desired color tone.

### Fifth Embodiment

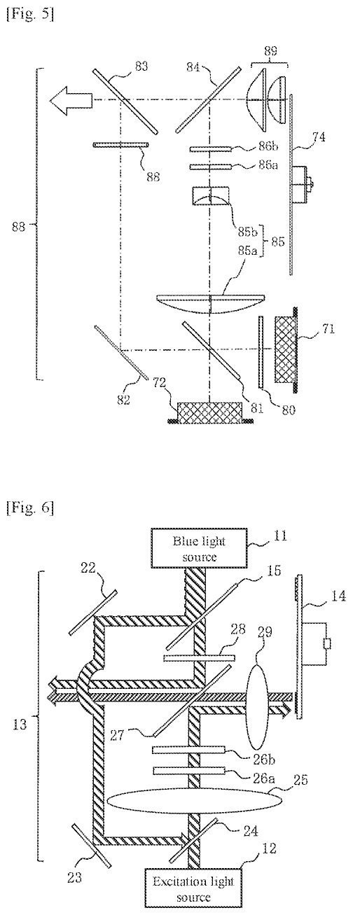

FIG. 5 is a top view schematically showing the configuration of a light source device according to a fifth embodiment of the present invention.

Referring to FIG. 5, the light source device includes laser module 71 that is a blue light source, laser module 72 that is an excitation light source, optical member 73, and phosphor unit 74. For convenience, only one laser module 72 is shown as an excitation light source, but in practice two laser modules 72 are provided. Laser modules 71 and 72 and phosphor unit 74 have the same structures as laser modules 31, 32a, and 32b and phosphor unit 34, respectively, described in the third embodiment.

Optical member 73 includes retardation plate 80, polarization beam splitter 81, mirror 82, dichroic mirrors 83 and 84, reduction optical system 85, fly-eye lenses 86a and 86b, diffusion member 88, and condenser lens 89. Retardation plate 80, polarization beam splitter 81, reduction optical system 85, fly-eye lenses 86a and 86b, diffusion member 88, and condenser lens 89 are basically the same as those of optical member 53 described in the fourth embodiment.

Blue LD light (linearly polarized light) emitted by laser module 71 is incident on the first surface of polarization beam splitter 81 via retardation plate 80. Blue LD light (P-polarized light) emitted by laser module 72 is incident on the second surface (the surface opposite to the first surface) of polarization beam splitter 81. Polarization beam splitter 81 integrates S-polarized blue LD light from retardation plate 80 and P-polarized blue LD light from laser module 72 into one optical path.

Integrated light integrated by polarization beam splitter 81 enters the first surface of dichroic mirror 84 through reduction optical system 85, which is made of multiple lenses 85a and 85b, and fly-eye lenses 86a and 86b. Reduction optical system 85, fly-eye lenses 86a and 86b, and dichroic mirror 84 have the same structure as reduction optical system 45, fly-eye lenses 46a and 46b, and dichroic mirror 47 described in the third embodiment. Dichroic mirror 84 reflects the integrated light toward phosphor unit 74. The integrated light reflected by dichroic mirror 84 is incident to phosphor unit 74 via condenser lens 89. Yellow fluorescent light emitted by phosphor unit 74 enters the first surface of dichroic mirror 84 through condenser lens 89.

The yellow fluorescent light that is transmitted through dichroic mirror 84 enters the first surface of dichroic mirror 83. On the other hand, the P-polarized blue LD light that has passed through retardation plate 80 and that is transmitted through polarization beam splitter 81 enters the second surface (the surface opposite to the first surface) of dichroic mirror 83 through mirror 82 and diffusion member 88. Dichroic mirror 83 has the characteristic of reflecting light in the blue wavelength range and transmitting light of other wavelength ranges within the visible wavelength range. Dichroic mirror 83 transmits the yellow fluorescent light incident on the first surface and reflects the blue LD light incident on the second surface in the transmission direction of the yellow fluorescent light. That is, dichroic mirror 83 color-synthesizes the blue LD light and the yellow fluorescent light into one optical path.

In the light source device of the present embodiment as well, a portion of the emitted light of laser module 71, which is a blue light source, can be turned to the side of the excitation light source, whereby the same effect can be obtained as in the first embodiment.

Further, forming retardation plate 80 and polarization beam splitter 81 so that the division ratio between S-polarized light and P-polarized light becomes the value of a desired division ratio allows output light of a desired color tone to be obtained.

### Sixth Embodiment

FIG. 6 is a schematic diagram schematically showing the configuration of a light source device according to a sixth embodiment of the present invention. Incidentally, in FIG. 6, the optical paths and the optical elements are shown schematically, and their sizes and shapes may be different from an actual example. For example, for convenience, the figure shows a state in which one optical path jumps over another optical path, but in practice, each optical path is straight and is arranged to intersect with each other in a spatially separated state.

The light source device of the present embodiment is different from the second embodiment in that beam splitter 15 is provided in place of retardation plate 20 and polarization beam splitter 21. The configuration is otherwise the same as that of the second embodiment.

In the light source device of the present embodiment, blue LD light emitted by blue light source 11 is incident on one surface of beam splitter 15. Beam splitter 15 splits the blue LD light from the blue light source 11 into a first blue split light and a second blue split light. Beam splitter 15 is, for example, a prism-type or plate-type beam splitter that uses a dielectric multilayer film. The beam splitter is capable of distributing the amount of light at a predetermined branching ratio (transmission/reflection distribution ratio). A beam splitter having a branching ratio of 50:50 is called a half-mirror. It is also possible to prepare a beam splitter having a branching ratio of 70:30 or 60:40. Beam splitter 15 may comprise at least one beam splitter having a predetermined branching ratio with respect to blue LD light or may constructed from a combination of a plurality of beam splitters having different branching ratios.

The first blue split light is incident to light integrating unit 24 via mirrors 22 and 23. Light integrating unit 24 integrates the first blue split light and blue LD light emitted by excitation light source 12 into one optical path.

On the other hand, the second blue split light is incident on the second surface of dichroic mirror 27 through diffusion plate 28. Dichroic mirror 27 color-synthesizes the yellow fluorescent light incident on the first surface and the second blue split light incident on the second surface into one optical path. Light synthesized by dichroic mirror 27 is the output light of the light source device of the present embodiment.

In the light source device of the present embodiment as well, a portion of the emitted light of blue light source 11 can be turned to the side of the excitation light source 12, whereby the same effect can be obtained as in the first embodiment.

In addition, forming beam splitter 15 so that the division ratio between the first blue split light and the second blue split light becomes a desired value allows output light of a desired color tone to be obtained.

The light source device of the present embodiment also exhibits the following effects: Due to deposits caused by optical dust collection of a laser light, the polarization characteristics of an optical member that includes a retardation plate or a polarization beam splitter may change. Therefore, in a light source device in which polarized light is used to split a beam, changes in the color tone of the output light and changes in illuminance are likely to occur due to changes in polarization characteristics. In contrast, since polarized light is not used to split a beam according to the light source device of the present embodiment, the color tone and illuminance of the output light can be stably maintained.

Incidentally, in a configuration that utilizes polarized light only on the blue light source side as in the second embodiment or the third embodiment and that does not utilize polarized light on the excitation light source side, changes in the color tone and illuminance hardly occur compared with a configuration in which polarized light is utilized on both the blue light source side and the excitation light source side.

### Seventh Embodiment

FIG. 7 is a schematic diagram showing the configuration of a light source device according to a seventh embodiment of the present invention. Incidentally, in FIG. 7, the optical paths and the optical elements are shown schematically, and their sizes and shapes may be different from an actual example. For example, for convenience, the figure shows a state in which one optical path jumps over another optical path, but in practice, each optical path is straight and is arranged to intersect with the other in a spatially separated state.

The light source device of the present embodiment is different from the second embodiment in that optical member 13 is configured to return a part of the emitted light of the excitation light source to the side of the blue light source. The configuration is otherwise the same as that of the second embodiment. Specifically, in optical member 13, polarization beam splitter 21A is used in place of light integrating unit 24, and retardation plate 20 is disposed between excitation light source 12 and polarization beam splitter 21A. Blue LD light emitted by excitation light source 12 is incident on the first surface of polarization beam splitter 21A through retardation plate 20. Polarization beam-splitter 21A has the property of reflecting S-polarized light and transmitting P-polarized light.

P-polarized blue LD light that is transmitted through polarization beam splitter 21A is used as excitation light for exciting the phosphor of phosphor unit 14. P-polarized blue LD light enters the first surface of dichroic mirror 27 through reduction optical system 25 and fly-eye lenses 26a and 26b. P-polarized blue LD light reflected by the first surface of dichroic mirror 27 is incident to phosphor unit 14 via condenser lens 29. Phosphor unit 14 emits yellow fluorescent light toward condenser lens 29. The yellow fluorescent light emitted from phosphor unit 14 is incident on the first surface of dichroic mirror 27 via condenser lens 29.

On the other hand, S-polarized blue LD light reflected by polarization beam splitter 21A is incident on the first surface of polarization beam splitter 21 through mirror 23 and mirror 22. Blue LD light (P-polarized light) emitted by blue light source 11 is incident on the second surface (the surface opposite to the first surface) of polarization beam splitter 21. Polarization beam splitter 21 transmits P-polarized blue LD light from blue light source 11 and reflects S-polarized blue LD light from mirror 22 in the transmission direction of the P-polarized blue LD light. That is, polarization beam splitter 21 integrates the P-polarized blue LD light and the S-polarized blue LD light into one optical path. Integrated light (blue LD light) integrated by polarization beam splitter 21 is incident on the second surface of dichroic mirror 27 through diffusion plate 28.

Dichroic mirror 27 transmits yellow fluorescent light and reflects the integrated light (blue LD light) in the transmission direction of the yellow fluorescent light. That is, dichroic mirror 27 color-combines the yellow fluorescent light and the integrated light (blue LD light) into one optical path. Light synthesized by dichroic mirror 27 is the output light of the light source device of the present embodiment.

In the light source device of the present embodiment as well, a portion of the emitted light of excitation light source 12 is turned to the side of blue light source 11 to achieve the action and effect described in the first embodiment.

Further, forming polarization beam splitter 21A so that the division ratio between P-polarized light and S-polarized light becomes a desired value allows output light of a desired color tone to be obtained.

The configuration for turning a part of the emitted light of the excitation light source to the side of the blue light source is not limited to the configuration shown in FIG. 7.

For example, in the configuration shown in FIG. 4, retardation plate 60 may be disposed between excitation light source 52 and polarization beam splitter 61, and laser module 51, which is a blue light source, may emit P-polarized blue LD light. Polarization beam splitter 61 integrates the P-polarized blue LD light from laser module 51 and the S-polarized blue LD light from excitation light source 52 into one optical path. Output light is obtained by color-synthesizing the integrated light and the yellow fluorescent light. Incidentally, excitation light source 52 may be used as the blue light source, laser module 51 may be used as the excitation light source, and laser module 51 may emit S-polarized blue LD light.

Further, in the configuration shown in FIG. 5, retardation plate 80 may be disposed between laser module 72, which is the excitation light source, and polarization beam splitter 81, and laser module 71, which is a blue light source, may emit P-polarized blue LD light. Polarization beam splitter 71 integrates P-polarized blue LD light from laser module 51 and S-polarized blue LD light from laser module 72 into one optical path. Output light is obtained by color-synthesizing the integrated light and the yellow fluorescent light.

In the second to seventh embodiments described above, for the purpose of increasing the speckle reduction effect, a rotational diffusion unit may be used instead of the diffusion plate or the diffusion member. The rotational diffusion unit includes a rotational diffusion plate for diffusing incident light, a first condenser lens provided on the incident-surface side of the rotational diffusion plate, and a second condenser lens provided on the exit-surface side of the rotational diffusion plate. The first condenser lens condenses the light incident to the rotation diffusion plate. The second condenser lens converts light that has passed through the rotational diffusion plate into a parallel light beam.

Any of the light source devices of the first to seventh embodiments described above can be used as the light source device of a projector. The projector includes a light modulation unit that modulates the emitted light of the light source device to form an image, and a projection lens that projects the image formed by the light modulation unit.

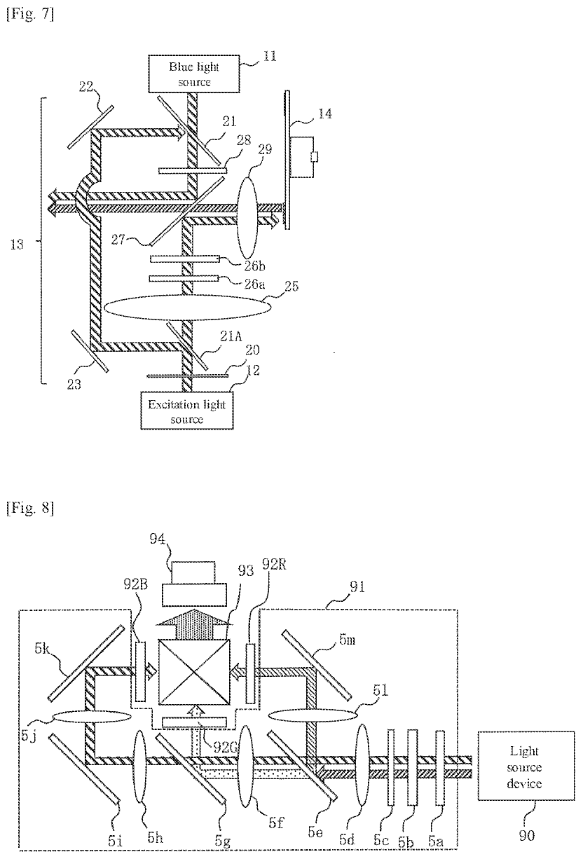

FIG. 8 schematically shows the configuration of a projector according to an embodiment of the present invention. The projector includes light source device 90, illumination optical system 91, three light modulators 92R, 92G, and 92B, cross-dichroic prism 93, and projection lens 94. Light source device 90 is the light source device described in any one of the first to seventh embodiments and emits a parallel light beam which is white light that includes yellow fluorescent light and blue LD light.

Illumination optical system 91 separates the white light emitted by light source device 90 into red light for illuminating light modulator 92R, green light for illuminating light modulator 92G, and blue light for illuminating light modulator 92B. Each of light modulators 92R, 92G, and 92B includes a liquid crystal panel that modulates light to form an image.

Illumination optical system 91 includes fly-eye lenses 5a and 5b, polarization conversion element 5c, superimposing lens 5d, dichroic mirrors 5e and 5g, field lenses 5f and 51, relay lenses 5h and 5j, and mirrors 5i, 5k, and 5m. White light emitted by light source device 90 is incident to dichroic mirror 5e through fly-eye lenses 5a and 5b, polarization conversion element 5c, and superimposing lens 5d.

Fly-eye lenses 5a and 5b are disposed so as to be opposed to each other. Fly-eye lenses 5a and 5b each include a plurality of microlenses. Each microlens of fly-eye lens 5a faces a respective microlens of fly-eye lens 5b. In fly-eye lens 5a, light emitted from light source section 90 is divided into a plurality of light beams corresponding to the number of micro lenses. Each microlens has a shape similar to the effective display area of the liquid crystal panel and condenses the light beam from light source unit 90 to the vicinity of fly-eye lens 5b.

Superimposing lens 5d and field lens 51 direct a principal ray from each microlens of fly-eye lens 5a toward the center portion of the liquid crystal panel of light modulator 92R and superimpose the image of each microlens on the liquid crystal panel. Similarly, superimposing lens 5d and field lens 5f direct a principal ray from each microlens of fly-eye lens 2a toward the center portion of the liquid crystal panel of each of light modulators 92G and 92B and superimpose the image of each microlens on the liquid crystal panel.

Polarization conversion element 5c aligns the polarization direction of light that has passed through fly-eye lenses 5a and 5b with P-polarized light or S-polarized light. Dichroic mirror 5e has a characteristic such that, of visible light, light in the red wavelength range is reflected and light in other wavelength ranges is transmitted.

Light (red) reflected by dichroic mirror 5e is irradiated to the liquid crystal panel of light modulator 92R through field lens 51 and mirror 5m. On the other hand, light (blue and green) transmitted through dichroic mirror 5e enters dichroic mirror 5g through field lens 5f. Dichroic mirror 5g has a characteristic such that, of visible light, light in the green wavelength range is reflected and light in other wavelength ranges is transmitted.

Light (green) reflected by dichroic mirror 5g is irradiated to the liquid crystal panel of light modulator 92G. On the other hand, light (blue) transmitted through dichroic mirror 5g is irradiated to the liquid crystal panel of light modulator 92B through relay lens 5h, mirror 5i, relay lens 5j, and mirror 5k.

Light modulator 92R forms a red image. Light modulator 92G forms a green image. Light modulator 92B forms a blue image. Cross-dichroic prism 93 has first to third incident surfaces and an exit surface. In cross-dichroic prism 93, the red image light is incident on the first incident surface, the green image light is incident on the second incident surface, and the blue image light is incident on the third incident surface. The red image light, the green image light, and the blue image light exit from the exit surface in the same optical path.

The red image light, the green image light, and the blue image light that have exited from the exit surface of cross dichroic prism 93 enter projection lens 94. Projection lens 94 projects the red image, the green image, and the blue image on a screen such that these images coincide with each other.

### EXPLANATION OF REFERENCE NUMBERS

1 First light source unit
1a First monochromatic light
2 Second light source unit
2a Second monochromatic light
3 Optical member
3a First split light
3b Second split light
3c Integrated light
4 Phosphor unit
4a Fluorescent light

1. A light source device comprising:
a first light source unit that emits a first monochromatic light;
a second light source unit that emits a second monochromatic light having the same color as the first monochromatic light;
an optical member that splits the first monochromatic light emitted by the first light source unit into a first split light and a second split light and that integrates the first split light and the second monochromatic light emitted by the second light source unit into one optical path; and
a phosphor unit that receives the second split light or the light integrated in the one optical path and emits fluorescence.

2. The light source device according to claim 1, wherein the phosphor unit is excited by light integrated into the one optical path to emit the fluorescent light,
further comprising a color-synthesizing unit that color-synthesizes the second split light and the fluorescent light emitted by the phosphor unit into one optical path.

3. The light source device according to claim 1, wherein the phosphor unit is excited by the second split light to emit the fluorescent light,
further comprising a color-synthesizing unit that color-synthesizes the light integrated into the one optical path and the fluorescent light emitted by the phosphor unit into the one optical path.

4. The light source device according to claim 2, wherein the optical member includes:
a retardation plate; and
a first polarization beam splitter that reflects a first polarized light and transmits a second polarized light that is different from the first polarized light,
wherein the first monochromatic light emitted by the first light source unit is incident on one surface of the first polarization beam splitter through the retardation plate, and the first polarization beam splitter splits the first monochromatic light into the first split light made of the first polarized light and the second split light made of the second polarized light.

5. The light source device according to claim 4, wherein the second light source unit emits the second monochromatic light made of the second polarized light, the second monochromatic light enters the other surface of the first polarization beam splitter, and the first polarization beam splitter emits the second monochromatic light from the one surface in the same optical path as the first split light that is made of the first polarized light.

6. The light source device according to claim 4, wherein the optical member further includes a second polarization beam splitter that reflects the first polarized light and transmits the second polarized light,
wherein the second light source unit emits the second monochromatic light made of the second polarized light, the second monochromatic light enters one surface of the second polarization beam splitter, the first split light made of the first polarized light enters the other surface of the second polarization beam splitter, and the second polarization beam splitter emits the second monochromatic light from the other surface in the same optical path as the first split light made of the first polarized light reflected by the other surface.

7. The light source device according to claim 4, wherein the second light source unit emits a plurality of light beams, which are the second monochromatic light, in the same direction and in a state in which each light beam is spatially separated from the others,
wherein the optical member includes a reflecting member that is provided inside the optical path that includes the plurality of light beams in a space that does not block each light beam and reflects the first split light made of the first polarized light in the same direction as the exit direction of the plurality of light beams.

8. The light source device according to claim 1, wherein the first light source unit comprises at least one first laser module provided with a plurality of laser diode chips, and
wherein the second light source section comprises a plurality of second laser modules, each module provided with a plurality of laser diode chips.

9. A projector comprising:
a light source device according to claim 1;
a light modulator that modulates light emitted by the light source device to form an image; and
a projection lens that projects the image formed by the light modulator.

10. The light source device according to claim 3, wherein the optical member includes:
a retardation plate; and
a first polarization beam splitter that reflects a first polarized light and transmits a second polarized light that is different from the first polarized light, wherein the first monochromatic light emitted by the first light source unit is incident on one surface of the first polarization beam splitter through the retardation plate, and the first polarization beam splitter splits the first monochromatic light into the first split light made of the first polarized light and the second split light made of the second polarized light.

11. The light source device according to claim 10, wherein the second light source unit emits the second monochromatic light made of the second polarized light, the second monochromatic light enters the other surface of the first polarization beam splitter, and the first polarization beam splitter emits the second monochromatic light from the one surface in the same optical path as the first split light that is made of the first polarized light.

12. The light source device according to claim 10, wherein the optical member further includes a second polarization beam splitter that reflects the first polarized light and transmits the second polarized light,
wherein the second light source unit emits the second monochromatic light made of the second polarized light, the second monochromatic light enters one surface of the second polarization beam splitter, the first split light made of the first polarized light enters the other surface of the second polarization beam splitter, and the second polarization beam splitter emits the second monochromatic light from the other surface in the same optical path as the first split light made of the first polarized light reflected by the other surface.

13. The light source device according to claim 10, wherein the second light source unit emits a plurality of light beams, which are the second monochromatic light, in the same direction and in a state in which each light beam is spatially separated from the others,
wherein the optical member includes a reflecting member that is provided inside the optical path that includes the plurality of light beams in a space that does not block each light beam and reflects the first split light made of the first polarized light in the same direction as the exit direction of the plurality of light beams.
